(19) United States
(12) Patent Application Publication
(10) Pub. No.: US 2008/0033735 A1
(43) Pub. Date: Feb. 7, 2008

(54) System and method for recording and distributing audio renditions of scripts

(76) Inventors: William Bryan Graham, Newport Beach, CA (US); Aric Laferriere, Los Angeles, CA (US)

Correspondence Address: JAFARI LAW GROUP, P.C., 801 N. PARKCENTER DRIVE, SUITE 220, SANTA ANA, CA, 92705, US

(21) Appl. No.: 11/490,605

(22) Filed: Jul. 20, 2006

(51) Int. Cl. G06Q 10/00; G06F 9/44

(52) U.S. Cl. 705/1; 705/7

(57) ABSTRACT

The invention is a system and method for recording and distributing audio renditions of scripts comprising a service provider and live actors wherein said live actors perform and record the roles in a studio, reducing the script to an audio file which may then be distributed to major film studios, production companies, production agents, writers, actors and anyone interested in listening to an audio format of a script. The present invention can be utilized as a tool for gaining a sense impression of the content, and more generally, the quality of a script, for example a screenplay.

### TECHNICAL FIELD OF THE INVENTION

The present invention relates in general to a system and method for allowing interested parties to glean a script's contents in a quick and easy manner, and in particular to reducing a script to audio form for an interested party, for example a producer, to listen and utilize as a tool for gaining a sense impression of the content, and more generally, the quality of a script, for example a screenplay.

### BACKGROUND OF THE INVENTION

Traditionally, studios involved in the entertainment industry have relied on executives and their staff to read through scripts before choosing one to produce. Scripts are typically submitted to a studio with the aid of an agent or through an agency. Once a studio receives a script, the script is read and reviewed, sometimes by more than one individual.

With the ongoing growth of the entertainment industry, for example the higher demand for films, movies, videos, and television programs, more scripts are being submitted to studios, producers, and anyone interested in producing a script than ever before. Studios and production companies alike amass scripts for months or even years before they are read for the first time. A production company may have an entire staff reviewing only two or three scripts at one time. Many scripts go unread and therefore are never discovered or considered due to time constraints. This is a problem to studios and similarly situated parties because, although they may possess a potentially valuable script, the inefficient process currently used for reviewing scripts today prevents the realization of many valuable projects.

Similarly, the inefficiency of studios or production companies is felt by writers that must wait for feedback, comments, rejections, or offers to purchase a script.

Part of the problem is the format of the script itself. Because a script is the blueprint for producing a motion picture, it must disclose the action and dialogue to the reader in text format before it may be converted into its final narrative art, such as film or television. This makes these documents long and more difficult to read.

Another part of the problem is that reading each script is time consuming. A mainstream film is typically just under two hours long, yet each script or screenplay may well be over a hundred pages long. Production companies receive thousands of scripts a year for consideration.

In previous years, the Hollywood film industry alone has experienced the submission of more than 50,000 screenplays in a single year from which only about 125 movies were made. This means production companies are trying to read as many scripts as possible in order to find marketable ones. A conventional 120 minute film necessitates about a 120 page long script, which takes about 1.5 hours to read for an experienced staff member of a studio (if the script is interesting). An executive producer or a member of his staff can read only between 7 and 10 scripts per day. Therefore, the entertainment industry in general will see more scripts being submitted each year, but less manpower to get through all of them.

For all parties involved, the slow process of obtaining and reading scripts is inefficient and time consuming. Reading the text format of a script means carrying around a relatively large document, which limits an individual's activities while reviewing the script, especially when there are multiple scripts in question. Additionally, studios must spend money delivering the hundreds and thousands of scripts they receive every year—whether it is to store them or send them to other locations. Storage space or an expensive carrier services must be used in handling these large documents.

Therefore, there is a need for converting scripts into a format that makes it easier to absorb the material, cuts down the time required to glean the contents of an entire script, enables the easy transportation of these large documents, and allows scripts to be more accessible and convenient to handle, while saving the time and money it takes to deliver these documents to various locations. Additionally, there is a need to make the process of reviewing scripts more efficient, less time consuming, and more effective than the current practices of today.

### SUMMARY OF THE INVENTION

To minimize the limitations in the prior art, and to minimize other limitations that will be apparent upon the reading of the specification, the present invention provides a system and method for recording and distributing audio renditions of scripts.

A system in accordance with the present invention comprises a service provider, a server, a database, a communication link between the server and users, and an acting crew to perform and record each text-formatted script submitted for conversion into an audio-formatted script. Additionally, a system comprises a user interface for users to interact with the server and order audio renditions of their scripts through the internet, access audio files online, listen to audio files online, and download audio files to their personal computers, mp3 players or other electronic devices which users can utilize to listen to the audio renditions of the text-formatted scripts users submit to said service provider for conversion into said audio-formatted scripts.

A method in accordance with the present invention includes the steps of obtaining scripts in their original text format, hiring actors, recording each scene into an audible format, and making copies of each converted script available to interested parties such as production companies and motion picture studios.

It is an object of the present invention to facilitate the reviewing process of scripts by studios and production companies or any other party interested in reviewing a script.

It is another object of the present invention to reduce the time and money consumed by the process of reviewing a script.

It is still another object of the present invention to make scripts more accessible to interested parties.

It is still another object of the present invention to provide various mediums of converted scripts available to users (i.e. CD's, mp3's, cassette tapes).

These and other advantages and features of the present invention are described herein with specificity so as to make the present invention understandable to one of ordinary skill in the art.

### BRIEF DESCRIPTION OF THE DRAWINGS

Now referring to the drawings in which like reference numbers represent corresponding parts throughout.

FIG. 1 illustrates a block diagram of a recording and distribution system of scripts in accordance with the present invention.

FIG. 2 illustrates a block diagram of one embodiment of a recording and distribution system of scripts in accordance with the present invention which includes a server and utilizes the internet.

FIG. 3 illustrates an exemplary embodiment of a system and method for recording and distributing audio renditions of scripts in accordance with practice of the present invention.

FIG. 4 is a flow chart illustrating a method for a service provider to receive, convert and distribute scripts in accordance with one embodiment of the present invention.

FIG. 5 is a flow chart illustrating a method for a service provider to receive, convert and distribute scripts on the internet through the use of a server based system in accordance with another embodiment of the present invention.

FIG. 6 is an exemplary webpage in accordance with an embodiment of the present invention.

FIG. 7 is an exemplary site map in accordance with an embodiment of the present invention.

### DETAILED DESCRIPTION OF THE DRAWINGS

In the following discussion addressing a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the invention.

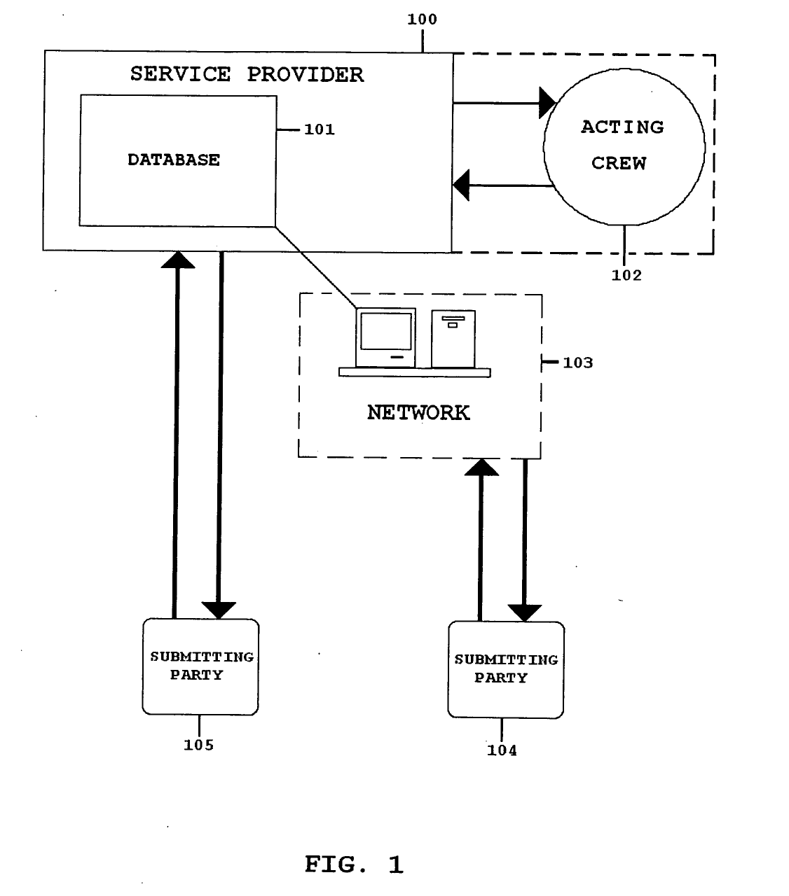

Now turning to FIG. 1, a block diagram is shown of a recording and distribution system for scripts in accordance with practice of the present invention. The different components and their interrelationships that enable a business to receive scripts in text format (text-formatted scripts), convert each one to an audio format (audio-formatted script), store them, make them accessible, and distribute them, is described in detail below.

The system comprises of the following illustrated elements: a service provider 100; a database 101; an acting crew 102; a network 103; and at least one user interface for a submitting party 104 to access database via the network. Additionally, a submitting party 105 could go directly to service provider 100 and physically submit a script for conversion into an audio format.

Service provider 100 may conceivably manage the system from any location in the world. If service provider 100 uses a server based system, service provider 100 can receive scripts, send them to an acting crew, make them accessible, and distribute them without having to leave service provider 100's place of business.

In one embodiment of the present invention, service provider 100 is located in an office building where office personnel are available to take a submitting party 105's script and provide copies of the audio recording to clients once the audio formatting of their script is complete.

In another embodiment, service provider 100 has both a server based system and a physical location where clients may come in and provide service provider 100 with scripts. Service provider 100 can manage the server based system at a physical location and serve walk-in clients during business hours as well.

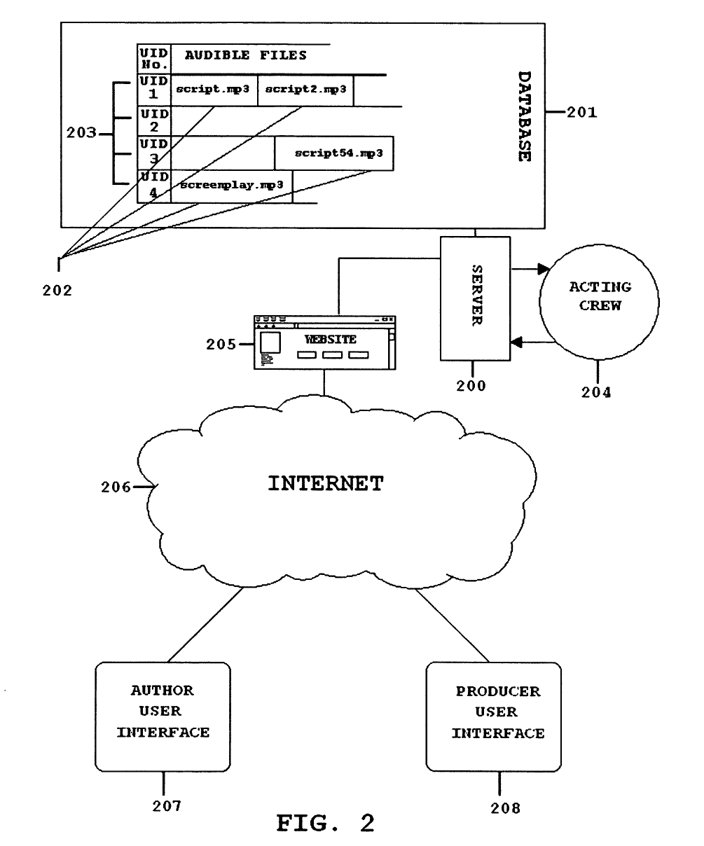

In yet another embodiment, service provider 100 does not have a physical location to conduct business, but only comprises of a server, further comprising of a database and a network, such as the internet. For example, and in no way limiting the scope of the present invention, service provider 100 may conduct all business via the internet using a website to receive orders and provide clients with audio-formatted scripts through the website. A more detailed description of this practice is discussed in FIG. 2 below which illustrates another embodiment in accordance with practice of the present invention.

Database 101 holds the submitted text-formatted scripts and each script's audio format, stored as text and audio files respectively. Database 101 can be created by a database manager with existing known technologies. In one exemplary embodiment of the present invention, database 101 can be created using technology such as relational architecture and commonly known computer language used to create, modify, retrieve and manipulate data from relational database management systems such as Structure Query Language (SQL). However, database 101 can also be a library of documented and organized files containing the same information stored in a directory with an index system containing the locations of all stored files, without departing from the scope of the present invention.

In another embodiment of the present invention database 101 is stored in a combination of database systems in service provider 100's physical business location, where a record of the audio files are kept electronically as well as physically in the form of tapes, minidisks, CD's or any other writable medium capable of storing an audio recording.

Acting crew 102 can be comprised of one or more actors capable of vocalizing, reading, performing, acting out, or portraying a variety of roles common in the entertainment industry.

In one embodiment, acting crew 102 is a single actor with the capability of making different voices so that he can perform and record different roles in any script.

In another embodiment, acting crew 102 is comprised of multiple actors capable of performing and recording multiple roles in any script.

In yet another embodiment, acting crew 102 is comprised of a computer program capable of creating audio renditions of the text in any script.

In yet another embodiment, acting crew 102 is comprised of a combination of the preceding (i.e. at least one actor or actress and at least one computer program).

In one exemplary embodiment of the present invention, acting crew 102 is comprised of an agency that is hired by server provider 100 and whose role is to find competent actors to perform and record at least one script submitted to service provider 100.

In another exemplary embodiment, acting crew 102 is a permanent or temporary group of actors who are hired by service provider 100 to perform and record at least one script submitted to service provider 100.

Network 103 can be as simple as a single computer, multiple computers, or the internet. In an exemplary embodiment of the present invention the internet is used so that clients can visit a website where they can access service provider 100's database 101, which contains each client's information and audio-formatted scripts. A more detailed discussion of an exemplary embodiment using a server based system and a website is disclosed now in turn.

Turning to FIG. 2, an exemplary embodiment of a server based system used by service provider 100 is shown in accordance with practice of the present invention. The system illustrated comprises: a server 200; a database 201; audio files 202; data repositories 203; acting crew 204; a website 205; a network 206; user interface 207 for a client author of a script; and user interface 208 for a client producer.

Server 200 can be any computer such as a minicomputer, microcomputer, mainframe computer, or any other computer commonly known as technologically appropriate. In an exemplary embodiment, server 200 is a World Wide Web server connected to the internet. In another embodiment server 200 is a distributed server system.

Database 201 can be created with known technologies as discussed in FIG. 1 above. Database 201 stores audio-formatted scripts 202 in data repositories 203, each repository storing data for each client identified by a corresponding user identifier (UID).

In FIG. 2 author user interface 207 and production user interface 208 are used to illustrate different types of clients the server based system can support. Each client may access their respective data repositories to view their submitted scripts by accessing network 206, or the internet, and visiting service provider 100's website 205.

In one embodiment, data repositories 203 are accessible to the general public and the entire database may be searched by any individual—making audio files 202 available to anyone. For example, and in no way limiting the scope of the present invention, a client submits a script to service provider 100 by logging on to network 206 and visiting website 205. Server 200 receives the text formatted script and sends a copy to acting crew 204. When acting crew 204 completes the recording of the script, a copy of the audio format is sent to server 200 and stored in database 201 in one of the multiple data repositories 203 which is accessible to all users. Similarly, a non-client may log on to the internet at a later time and search database 201 for client's audible file. Server 200 retrieves the audible file for non-client and non-client may listen to client's file.

In another embodiment, audio files 202 are only available to the client or clients who have exclusive access to the data repository in which a particular audio file is stored. For example, and in no way limiting the scope of the present invention, an author of a script utilizes user interface 207 and a producer user utilizes producer user interface 208 to connect to network 206 and visit server 200's website 205. After log-in and gaining access to server 200, both clients submit their script via the internet, either as an attachment to an email sent to server 200, or directly through the website, or in any other manner in which each client can send their scripts to server 200 for conversion into an audio format. Server 200 receives the scripts from both clients and sends each script to acting crew 204 for recording. Acting crew 204 provides server 200 with audio formats of each script and server 200 stores the audio-formatted scripts in database 201. Because author client desires to have his script heard by as many producers as possible, server 200 makes author client's audible file available to all clients and the general public that visit the website, including producer client utilizing user interface 208.

On the other hand producer client may not desire to have his or her audio-formatted scripts posted for anyone to view. Because producer client does not desire to have anyone else access his or her audio files, when author client logs on to server 200's website, he or she will not be able to hear or see what scripts producer client has had converted into audio-formatted scripts.

A more detailed description of the different alternatives available to clients is discussed in greater detail below, in another exemplary embodiment of the present invention. A server based system for recording and distributing audio renditions of scripts is illustrated and described in turn.

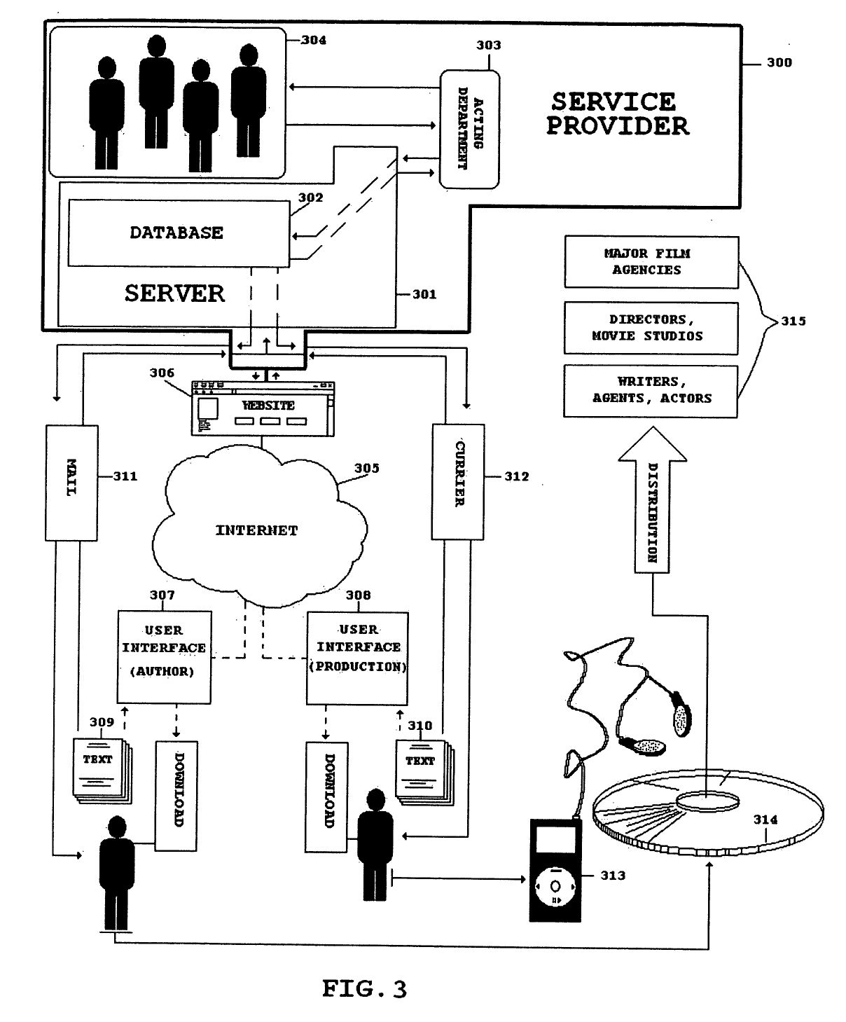

Now turning to FIG. 3, the components of an exemplary embodiment of a system and method for recording and distributing audio renditions of scripts in accordance with practice of the present invention is illustrated, showing the various alternatives available to different clients.

The exemplary embodiment comprises of the following components: service provider 300; server 301; a database 302; an acting department 303; a group of actors 304; a network 305; a website 306; a user interface 307 for authors of scripts; a user interface 308 for production companies or private parties that desire to have their scripts converted to audio format; scripts 309 and 310; a mail service 311 such as the Unites States Postal Office; a currier service 312; at least one device capable of containing at least one audio formatted script, such as an mp3 player 313 or a compact disc (CD) 314; and marketing channels 315.

Service provider 300 is shown as having an acting department 303 and at least one or more permanent or temporary actors or actresses 304 working for service provider 300.

In one embodiment of the present invention, the group of actors 304 is comprised of actors or actresses that can portray a variety of typical roles common in the entertainment industry, for example and in no way limiting the scope of the present invention, group of actors 304 is comprised of actors or actresses that vocalize, read, perform, act out, or portray a variety of typical roles common in the entertainment industry.

Server 301 and database 302 are created as discussed above in FIGS. 1 and 2. In one embodiment, database 302 comprises both digital and physical files, such as audio versions of each script available in mpeg, wav, aiff, and mp3 files as well as CD's and text formats of each script that is submitted by clients.

Service provider 300 also has a website 306. In one embodiment website 306 allows marketability of the product and services in addition to providing some clients, such as author's of scripts, a tool to market themselves and their script through the website and through use of their audio files provided by service provider 300 on the website 306 as downloadable files that can be distributed by different users.

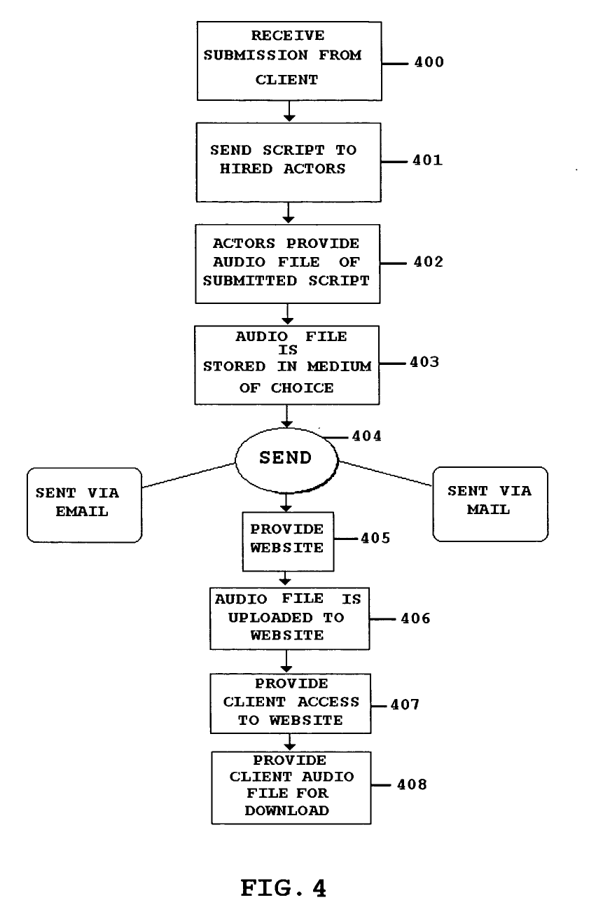

For example, and in no way limiting the scope of the present invention, an author might connect to the internet 305 utilizing user interface 307 and visit service provider 300's website 306. Once service provider 300 grants access, a process discussed in detail below at FIG. 4, author user can submit his or her script 309 for conversion into an audio format. Author user 307 can submit his or her script 309 to service provider 300 by sending the text formatted script 309 via regular mail to a provided address. Upon receipt, service provider 300 processes script 309 enters it into the database for record keeping, categorizing and filing script 309 accordingly.

Service provider 300 provides acting department 303 with script 309. The script is reviewed and the appropriate actors 304 are given roles, including a narrator of script 309. Acting department 303 provides actors with a recording studio and proper equipment to perform and record the necessary audio components of the script.

Once the audio components of script 309 are recorded and stored as an audio file, the acting department provides server 301 with a copy to store in database 302. Server 301 can then upload the audio file in database 302 and make the file accessible through website 306.

Once available on website 306, author user may download his or her audio file to a CD 314 and distribute CD 314 to different marketing channels 315, such as major film studios, other writers, agents, or the general public.

In another example, and in no way limiting the scope of the present invention, a producer may similarly go to website 306 and submit multiple scripts 310 via a carrier 312. Once received, service provider 300 takes the same steps to have scripts 310 performed and recorded by actors 304.

Once those files are made available, producer can download the audio files to an electronic device 313 such as an ipod™, and begin listening to each script. This way, a producer the convenience to listen to a script during lunch, at coffee shops, or even while driving.

In an exemplary embodiment of the present invention, a user may access his or her audio-formatted scripts, and any other audio file available on the website, from anywhere in the world by using a Personal Computer (PC), a laptop computer, a PDA device, or any other electronic device suitable for listening to an audible file. For example, and in no way limiting the scope of the present invention, a user or client wirelessly downloads content into a portable audio player, such as a wireless iPod.

In another exemplary embodiment of the present invention, website 306 also includes copyright service information, available to authors of scripts, to provide authors who have yet to copyright their work and opportunity to do so before or after submitting their scripts for conversion into audio format.

An exemplary method for service provider 300 to receive scripts and provide audio files of each script via the internet using a website, is disclosed in turn.

FIG. 4 is a flow chart illustrating a method for service provider 300 to receive, convert and distribute scripts in accordance with one embodiment of the present invention. The method is explained in the order shown below; however the following steps may be taken in any other conceivable sequence without deviating from the scope of the present invention.

Now turning to step 400, service provider 300 receives a script in text format from a submitting party or client.

At step 401, service provider 300 sends the script to acting department 303. Hired actors may be hired directly by service provider 300 or may be accomplished by hiring an agency to provide the actors themselves. The script is performed in its entirety, scene by scene, but only the audio components of the script are recorded.

In an exemplary embodiment, the recorded audio components are edited for quality and content such as adding sound effects and a soundtrack.

In another exemplary embodiment, only the dialogue and narration in the script are recorded. For example, and in no way limiting the scope of the present invention, an individual is designated as narrator to read the scene descriptions and actions as written by the author of a screenplay submitted to service provider 300. Additionally, character roles in the script are performed by other actors from acting department 303. Subsequently, only the narration, the scene and action descriptions, and character dialogue in the script are recorded without sound effects or a soundtrack. Furthermore, the actors or actresses that vocalize, read, perform, act out, or portray their roles in the screenplay, do so in a manner to avoid influencing the listener, such as an executive producer, with a particular acting style. In this way, the audio-formatted screenplay may be utilized by the listener as a tool to gain the sense of the screenplay—avoiding any character driven performances or over-acting that might affect the author's intent. Once the actors have performed and recorded their performance, acting department 303 must provide a copy of the audio-formatted script or screenplay.

At step 402, acting department 303 provides service provider 300 with a final version of the audio format of the submitted text-formatted script. The final version can be in any medium such as a CD, a videotape, a computer audible file, a minidisk, a streaming media source, or any other medium in which the audio format may be stored in database 302.

At step 404, service provider 300 chooses to store the audio file in the same medium in which the audio was recorded or in any other suitable medium available to server 301. For example, and in no way limiting the scope of the present invention, the audio-formatted script is received by service provider 300 from acting department 303 in a CD. Service provider 300 takes the CD and transfers the file into database 302. This audio file is stored for later use or kept as a record, or sent directly to client at step 404. There are a number of ways to achieve this task which will be discussed in turn.

In one embodiment of the present invention, service provider 300 sends a copy of the audio-formatted script via mail. For example, and in no way limiting the scope of the present invention, service provider 300 may use a mail service to send a CD containing the audio-formatted script and a copy of the script to the client. Another example, and in no way limiting the scope of the present invention, service provider 300 may use a mail service to send a tape containing the audio-formatted script and a copy of the script to the client. Another example, and in no way limiting the scope of the present invention, service provider 300 uses FedEx to send an mp3 player containing an audio file of the audio-formatted script to a client. In another example, and in no way limiting the scope of the present invention, service provider 300 uses United Postal Services to send a minidisk containing the audio-formatted script to the client.

In another exemplary embodiment of the present invention, instead of physically delivering the audio-formatted script to a client, service provider 300 posts an audible file on a website where only the client has access to the file. For example, and in no way limiting the scope of the present invention, when service provider 300 originally receives the audio-formatted script from the acting department at step 402, service provider 300 stores a copy of the audio-formatted script in the client's file. The stored file containing the audio-formatted script can be any computer audible file such as an mp3. This file can be posted and accessed every time a client logs on to the website using a provided user ID and key.

If the present invention is practiced as discussed above, and the file is sent directly to clients, service provider 300 moves on to the next submitted text-formatted script for conversion into a new audio-formatted script.

However, in another embodiment of the present invention, service provider 300 stores a copy of the audible version of the script in a server where it may be accessible to private parties or to the public. If this is the case, the following steps 405, 406, and 407, may be taken to provide clients or the public with a copy of the audible format of the script.

At step 405 the audible format of the script is uploaded to a website where it can be accessed by the submitting party or client.

At step 406 the client is granted access to the website and at step 407 the client is provided with a copy of the audible file for download. In one embodiment, a submitting party can access their audio-formatted script from anywhere in the world. For example and in no way limiting the scope of the present invention, a submitting party can access the internet with a device capable of receiving information wirelessly in multiple locations around the world. Upon being granted access, submitting party can download their file into their wireless device, disconnect from the internet, and proceed to listen to their audio-formatted script.

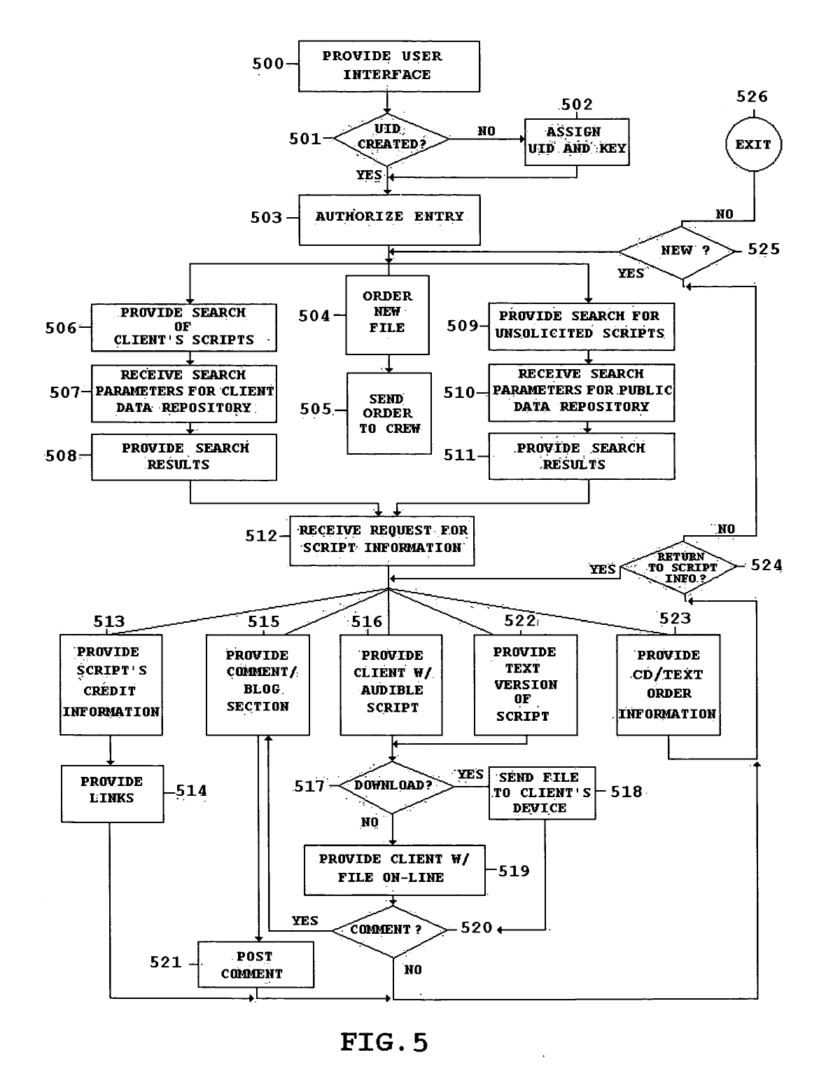

A more detailed description of an embodiment of the present invention, which involves the use of a website, is illustrated in FIG. 5 and discussed in greater detail in turn.

FIG. 5 is a flow chart illustrating a method for service provider 300 to provide service using website 306 in one embodiment of the present invention. The method is explained in the order shown below; however the following steps may be taken in any other conceivable sequence without deviating from the scope of the present invention.

At step 500, service provider 300 creates or provides future and existing clients with a user interface, such as website 306. A submitting party or anyone with access to the internet may visit website 306. In one embodiment of the present invention, website 306 is only accessible to paying members or clients. In another embodiment of the present invention, website 306 is free and anyone can visit and download any available content on the website. In yet another embodiment of the present invention, website 306 contains content for the public and content available only to member clients, such as audio-formatted scripts available for download only to paying clients.

If user is already a member of website 306 and has been provided with a user identifier (UID) and key, then service provider does not need to provide a new UID and key. If however, the client has not been provided with one, service provider 300 must assign a UID and key at step 502. Once a user has obtained a UID and key, they can log in to website 306 to access available information by entering their UID and key.

At step 503 service provider 300 grants access to the user after verifying the UID and key user has entered. The user is granted access to website 306 or section of website 306 accessible to that particular user. For example, and in no way limiting the scope of the present invention, a user might not be a member of the site or a paying client and therefore only has access to a public section of website 306 where only certain material is available. In another example, and in no way limiting the scope of the present invention, a user who is a client, has access to their own company's or personal file on website 306 which is used to store any scripts which have been converted into the audible format. The client user thus, would be granted access to the entire website while the user who is not a client is only granted access to a section of website 306 provided for the general public.

Once access is granted, the user is provided with a number of choices and service provider 300 may take the following steps depending on what the user chooses to do or what information the user decides to view on website 306.

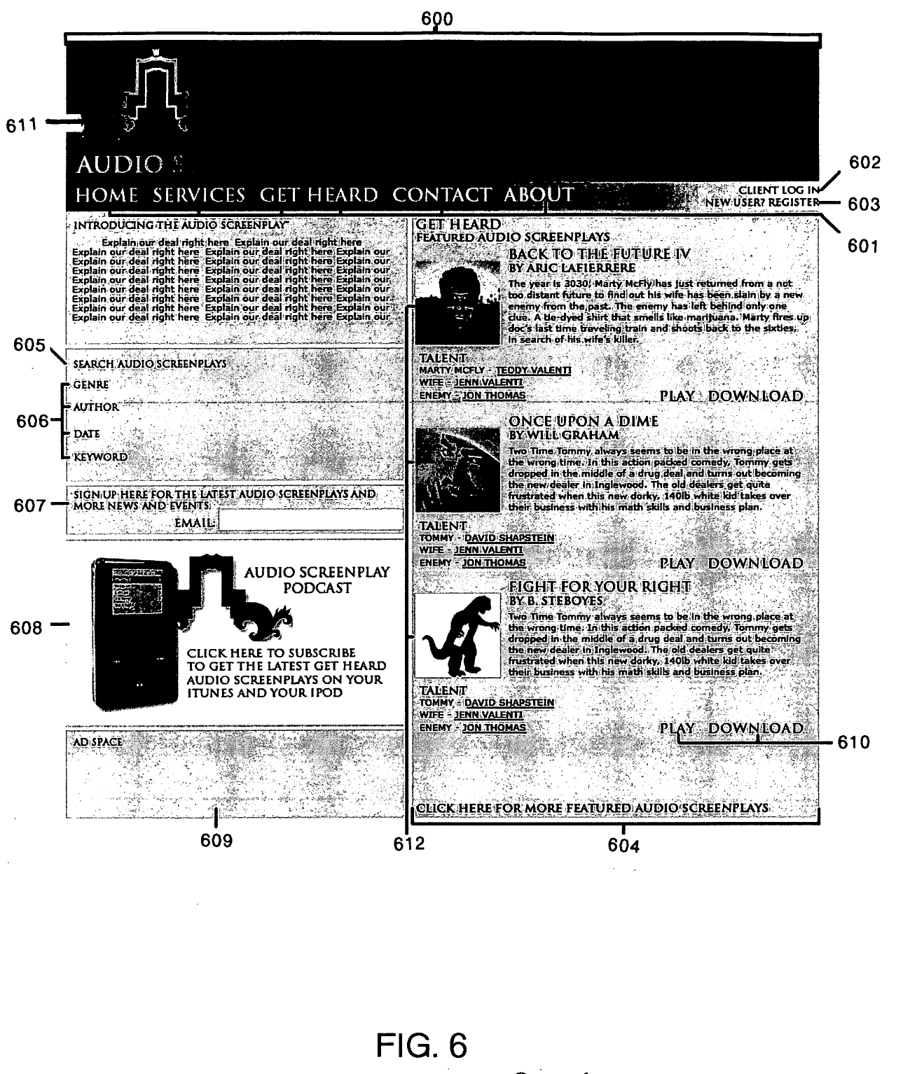

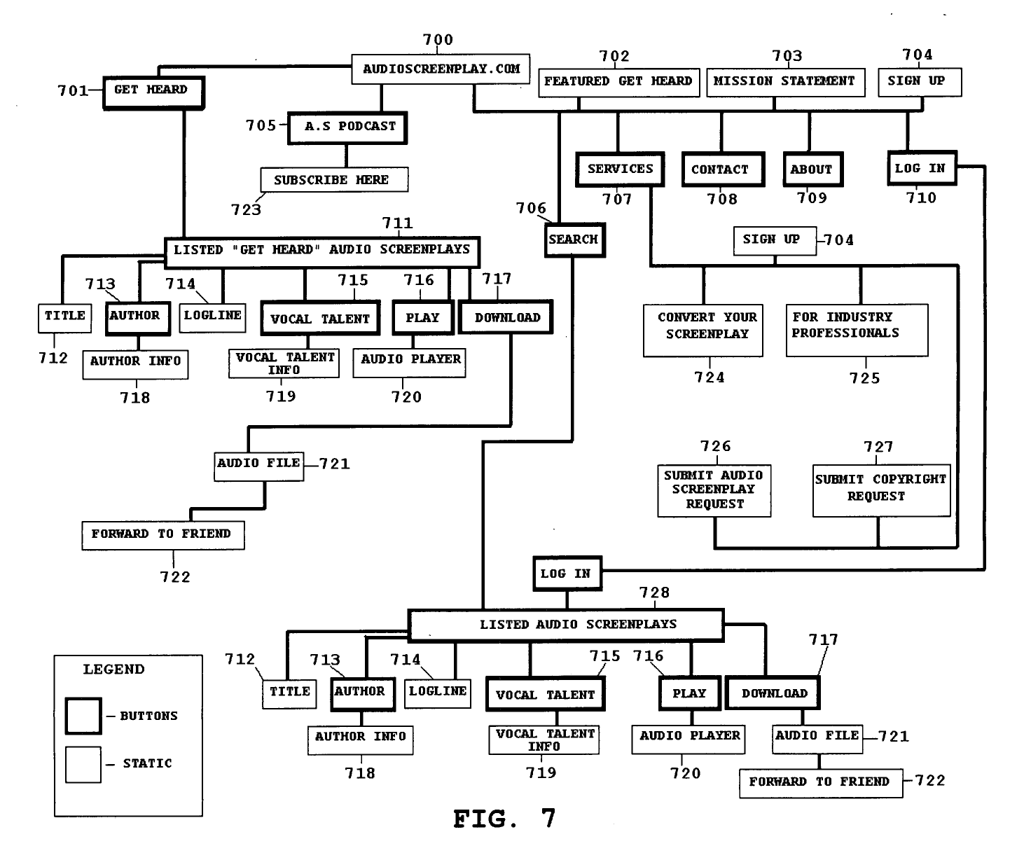

In one embodiment of the present invention, the user is provided with icons and links indicating what information is available to them. For example, and in no way limiting the scope of the present invention, the user is provided with one link to their company's folder, another link to a searchable database, and another link to a public section of website 306. An exemplary website and site map are illustrated in FIGS. 6 and 7 respectively.

At step 504 service provider 300 receives a new order for a script to be converted into audible format and at step 505 service provider 300 sends the order to acting department 303 to begin the recording process discussed in FIG. 4 above.

At step 506, service provider 300 provides a search of a client's data repository. This search can be any type of search, such as a Boolean search, a name search, or a search by categories, or a combination thereof.

In an exemplary embodiment of the present invention, the search is a search by category. For example, and in no way limiting the scope of the present invention, a production company who has submitted several hundred scripts for conversion, can log on to access their data repository holding each script's audible version, and search for comedies.

In another embodiment of the present invention, the searchable data repository is searched by performing a Boolean search. In yet another embodiment of the present invention, the search is performed by a combination of methods that are known today and used to perform database searches. More options for performing searches are discussed below in FIGS. 6 and 7.

At step 507 service provider 300 receives the search parameters and retrieves the information from the database repository. At step 508 the search results are provided for the client user. The search results can be provided in a number of ways.

In one embodiment, the search results are the titles of the scripts. In another embodiment, the search results are the author's name of each script. In still another embodiment, the search results are links to the downloadable files of the audible versions of each script. In still another embodiment, the search results include headshots of the actors involved in the scripts and the parts they played. In still another embodiment, the search results are a combination of different information associated with each audio-formatted script provided in the search results list.

For example, and in no way limiting the scope of the present invention, a results list for a search on science fiction scripts, could include the name of each script, the name of the actors involved in the audio version, the title of the script, and any other information available about the script with links to other web pages.

In an exemplary embodiment, website 306 is composed of two sections, a private section and a public section. Any user can access the section available to the public, or non-clients, once they are logged in. If a client decides to view or search the database of scripts converted for writers or anyone interested in having their scripts available to the public, the client too may search the database for those audio-formatted scripts.

At step 509, service provider 300 provides a search and search parameters for the user desiring to access the public section of website 306. This search can be any type of search, such as a Boolean search, a name search, or a search by categories. For example, and in no way limiting the scope of the present invention, a user may search for comedies and science fiction scripts that have been posted. The search results would list all scripts available under either of those categories.

At step 510, service provider 300 receives the search parameters selected by user and retrieves the matching data from the database. Then, at step 511, service provider 300 provides the user with the retrieved results.

After the results are provided for the user, the user selects the desired script to listen to and at step 512 service provider 300 receives the request for a particular audible file and its related information.

The following steps 513, 515, 516, 522, and 523 may be taken in a completely different order every time the user logs on to website 306, depending on what information the user desires to accesses on a particular visit to the site. The user could request information involving one or all or none of those steps. These steps and the remaining steps are discussed in turn.

At step 513 service provider 300 provides a script's credit information. Next, at step 514 a links page or list is provided for users. In one embodiment, each vocal talent or actor, and each author of a script is listed with links to each individuals personal page. In another embodiment, each link may be a link to a separate website for every individual listed in the credit's section.

Then, at step 515, service provider 300 also provides the user with links, if they are available, to websites associated with the individuals on the credits of a script.

At step 515, service provider 300 provides user with a blog or comment section for that particular script. In one embodiment of the present invention, the comment section includes a chat room where users can discuss different opinions on a particular script or on a number of scripts they have recently listened to. In another embodiment of the present invention, the comment section includes the email of the script's author so that interested users can send an email to the author with any comments suggestions or any other communication regarding the script they have accessed.

In still another embodiment of the present invention, the blog or comment section is a section where users can write comments to the writer and the writer can receive feedback. The section also allows others to see what kind of responses a script has been getting from other users. Once the comments have been made the user can return to view more information on a particular script. If the user does not wish to view any other information on that particular script then user may perform another search, submit a new order, or exit website 306 (see steps 525, 525, and 526 below).

At step 516 service provider 300 provides the user with an actual audible file of the script that has been recorded by acting department 303 as discussed above in FIGS. 2 and 3. If the user decides to download the file at step 517, then the server receives the request and sends the user the file at step 518. The user may download it to an mp3 player such as an ipod™, or they may leave it on their computer and save the file for later listening.

If the user does not wish to download a copy of the file then service provider 300 skips step 518 and at step 519 provides user with an audible file available on website 306.

Once the script's audible file has been listened to or downloaded, the user may choose to comment on the script at step 520. If the user decides to make a comment or view the comments section, service provider 300 repeats step 515 and provides the comment or blog section for the user. If the user inputs a comment or remark, service provider 300 then follows step 521 and posts the comment for other users to see.

At step 522, service provider 300 provides user with a text version of the script. This can be a PDF file or a Word file or any other type of file which can contain a text version of the script which was converted for listening. A user may want to read the script as they listen to it or simply read the script. The same step 517 as with the audible file is followed.

At step 517 service provider 300 provides the opportunity for user to download the script's text version. If the user decides to download the script, then service provider 300 sends the text version of the script to user at step 518. If the user does not wish to download a copy of the text version, then the user is provided with an on-line version so that the user may view and read the script.

As with the audio version, service provider 300 provides user with the opportunity to make a comment or suggestion at step 520. If the user desires to make a comment the same steps 515 and 521 are taken by service provider 300 to assure that the comment is received and posted for other users to read.

At step 523 service provider 300 provides the user with order information. This may be a link to a separate order form the user fills out, or an online form the user submits, or simply provide contact information such as a telephone number for a user to order a particular script that may be available for ordering. For example, and in no way limiting the scope of the present invention, the order form can be used to order a CD containing various scripts on audio format.

At step 524 user decides whether or not to continue viewing information about the same script. If the user desires more information on a particular script then they return to that script's file discussed above at step 512. If they desire to do a new search for another script at step 525, service provider 300 repeats steps 506, 507, and 508 for user to search through their own databank. If on the other hand, at step 525 user desires to search through the scripts available to the general public, then service provider 300 repeats steps 509, 510, and 511. Additionally, if user decides to submit a new script for conversion into audible format, then server repeats steps 505 and 505 as discussed above.

FIG. 6 is an exemplary website in accordance with one embodiment of the present invention. This website can serve as a way to market products and services provided by a service provider in accordance to practice of the present invention.

Website 600 is comprised of links 601, client log-in link 602, new user registration link 603, featured audio-formatted scripts section 604, search function section 605, with search function parameters 606, newsletter subscription sign up 607, downloadable media service 608, ad space 609, play and download buttons 610, service provider logo 611, and featured audio screenplay images 612.

Links 601 comprises of links that regard to the services and products service provider 300 has to offer, and how to get a hold of service provider 300 for business purposes or service support.

Client log-in link 602 is for existing users that have submitted scripts for conversion into audio-formatted scripts, and have a data repository (see FIG. 2) assigned to them. In one embodiment, an existing user or client may input a UID and key to provide service provider with identification before being granted access to their private information, including any audio-formatted scripts a user or client may possess in their provided data repository.

New user registration link 603 leads a new user to a log-in section. In one embodiment of the present invention, a user can log in for free to have access to the material available to the general public on website 600.

In another embodiment of the present invention, a new user must log-in only if he or she desires to become a client and submit at least one script to the service provider host to website 600.

Featured audio-formatted scripts section 604 is comprised of different audio-formatted scripts that are made available to the general public or visiting user of website 600. In one embodiment, these are scripts that have been submitted by an author looking to market their script or screenplay by allowing as many people as possible to listen to their script or screenplay on the site. Additionally, these featured scripts or screenplays are downloadable by user of the website.

In one embodiment, users may download these scripts for a fee. In another embodiment, users can download these featured audio-formatted scripts for free.

Search function section 605 is made available to users to facilitate the process of locating a particular script, and to allow for focused searches of scripts for those users not looking for a particular script but for a particular kind of script. Users can focus their search by using provided search function parameters 606.

Website 600 also provides a newsletter subscription sign up 607. Here, users can subscribe to receive news and events related to the industry. In one embodiment, this section can be used to alert users of events that are occurring in which users may attend either for entertainment or for marketing purposes.

Downloadable media service 608 can be any service that offers media for download and updates such media constantly, so users of the service may check from time to time for updates on new audio. In one embodiment of the present invention, service provider host to website 600 contracts such media service 608 to provide website 600's users with the option of constantly receiving updates of audio-formatted script files featured on website 600. For example, and in no way limiting the scope of the present invention, host of website 600 contracts Podcast as their media service 608 to offer users of website 600 the service of constantly providing updated audio-formatted script files. This way, users may download new audio-formatted scripts that are being featured on website 600.

Additionally, ad space 609 is provided for marketing of related services or products or as a means for service provider host to website 600 to attain another source of revenue.

In order to access the actual featured audio-formatted scripts in section 604, play and download buttons 610 are provided for users.

Finally, service provider logo 611 serves as a way for the services and products to be recognized by users and help advertise the service provider host to website 600, and images 612 are used to promote, identify and market each featured audio-formatted script, in this case screenplays.

A detailed description of each component of an exemplary website is disclosed below in FIG. 7 discussing an exemplary site map to a website, in accordance with practice of the present invention.

FIG. 7 illustrates an exemplary site map 700 to a website in accordance with practice of the present invention. A detailed discussion of the site map, immediately below, discloses each of the components of an exemplary website and their interrelationship.

The components for this exemplary website 700 are as follows: audio-formatted scripts link 701 labeled ‘Get Heard’; featured audio-formatted files 702, labeled ‘Featured Get Heard’; mission statement 703; sign up section 704; media service link 705; search function 706; services section 707; contact section 708; service provider information link 709, labeled ‘About’; log-in link 710; listed audio-formatted scripts page 711; file title 712; author information link 713; logline page 714; vocal talent link 715; play link 716; download link 717; author information page 718; vocal talent information page 719; audio player 720; audio file 721; forward file function 722; media service subscription page 723; convert your screenplay order page 724; marketing information page 725, labeled ‘For Industry Professionals’; submit audio screenplay request page 726; submit copyright request page 727; and listed audio screenplays 728.

Link 701 is a section which will provide access to the audio-formatted scripts submitted by screenwriters who would like their script to be listened to by the public or anyone that visits the site. In one embodiment, the audio-formatted script will be listed in order received and each will contain specific features (see 712 thru 722) however, the files listed in this section may be displayed in any other form without limiting the scope of the present invention. For example, and in no way limiting the scope of the present invention, the this section could display an image or icon representing the author of the scrip, or the script itself.

‘Featured Get Heard’ section 702 appears on the homepage of website 700, here labeled audioscreenplay.com. In one embodiment, this section may cost extra since it is one of the first things people will see when they enter the site, giving the script more exposure, and thus further adding marketability.

Mission statement section 703 will display a mission statement; a brief description of what the service provider 300 does and what goals service provider 300 seeks to accomplish.

Section 704 is a sign-up section for users to enter their email address to receive news and updates on audio-formatted scripts. In one embodiment, news and updates can be provided to users wirelessly to their mobile phones. In another embodiment, news and updates can be provided to users' emails and mobile phones.

Downloadable-media service link 705 allows users access to information describing what media files will be available and provide a sign up page to subscribe to the downloadable-media service (see, section 723). In one embodiment, section 705 may also feature a few of the latest downloadable-media files to be viewed, listened to, or downloaded. For example, and in no way limiting the scope of the present invention, the media service could be Podcast (see section 723 below).

Search function 706 allows a user to search the publicly listed audio-formatted scripts to find a more specific group of screenplays. In one embodiment, the search criteria may include authors listed, genres, vocal talent, a keyword search, and a search by themes.

For example, and in no way limiting the scope of the present invention, an authors listed search could include a search function where a user may type in a specific name or part of a name and get all his/her listed audio-formatted scripts.

A genre search criteria may include a search function where a user may choose a genre, such as comedy, and get all listed comedy Audio-formatted scripts.

A vocal talent search criteria may include a search function where a user may type in a name or part of a name to get all listed audio-formatted scripts a particular actor/actress (reader) has performed in.

A keyword search criteria may include a search function where a user may type one or multiple words and search the database and return listed audio-formatted scripts with keywords within the title or logline.

A themes search criteria may include a search function where one can narrow their search in certain themed criteria. Themed criteria can include: animation, budget range, ethnicity, events, family, locations, time period, screenplay adaptation, culture/society, viewing audience, special effects, television, rating, and so forth.

Services section 707 will explain in great detail all services service provider 300 has to offer and to whom. In one embodiment, this information may include the types of clients, the types of users on the website, and in what direction is the company headed with respect to products and services service provider 300 is offering and planning to offer in the future. This section leads to other pages 724, 725, 726, and 727, discussed in more detail below.

Contact section 708 will give general contact information for service provider 300. In one embodiment, the contact section may include an address, a phone number, and an e-mail address.

In another embodiment of the present invention, contact section 708 may also list FAQ's, and any other additional corporate information. In yet another embodiment, contact section 708 may additionally link users to the services section 707 for those users who would like to submit an audio-formatted script request (see section 726).

Service provider information link 709, labeled ‘About’, leads to a page which provides some history of the audio-formatted scripts system and other links to associated websites. In one embodiment, service provider information link takes a user to a page where other links to other pages offering complementing products or services. For example, and in no way limiting the scope of the present invention, the information available through link 709 could include links to the websites of several production companies, film studios, and agencies.

Log-in section 710 is for clients or users who have submitted at least one script, and had at least one script converted into audio format, to view their displayed script or scripts on a password protected section of the site. Log-in section 710 provides, to those users or clients, access to their own data repositories. For example see FIG. 2).

In one embodiment of the present invention, a client may enter their password to receive access to their own private section of listed audio-formatted scripts. This section or page may contain the same information and functions found on the main home page.

For example, and in no way limiting the scope of the present invention, a client's private section will contain a logline similar to logline 714, a vocal talent information link that leads to a vocal talent information page similar to vocal talent link 715 and vocal talent information page 719. Similarly, the page will contain an audio player, where client may hear audio files, and a download option for a client who wishes to download a file from his data repository. Additionally, the private section may also include the option to forward audio files to friends similar to the public section's forward function 722 (discussed in detail below). If the list of audio-formatted scripts is long enough (i.e. a client has a data repository containing several hundred scripts a search function will be added for convenience.

Section 711 here labeled Listed “Get Heard” Audio-Screenplays, displays after clicking the Get Heard link 701. It will list all Audio-formatted scripts from most recent to least recent. If search 706 function is used, it will list the audio-formatted scripts results.

Title 712 is the title of a script accessible through section 728. Author link 713 is a link to information on the screenwriter or representative of the script.

Logline 714 provides a user with information regarding the script. In an exemplary embodiment, this information includes a brief description of a script.

Link 715 provides access to a ‘Vocal Talent’ section. In an exemplary embodiment, a list of the live actors used during the recording of a script is provided. See vocal talent information page 719 below.

Play link 716 will launch the Audio Player 720 so one can listen to the script online and download link 717 will download an audio file 721 to the user's computer or device user is utilizing in when accessing website 700.

Author Info section 718 may contain the author's contact info, photo, biography, credits, the author's description of the script in audio, video, or text format, and any other optional information the author may want to include.

Vocal Talent Information section 719 may contain the vocal talent's contact information. In one embodiment of the present invention, the vocal talent's information page may include a photo, a biography, credits, and any other optional information the vocal talent may want to include.

Audio Player 720 is software that plays the audio-formatted scripts with the functions to stop, play, pause, fast forward, rewind, and volume control, on the website itself. The audio player can be any type of media player available to users for listening to media such as Windows Media Player and RealPlayer.

Audio file 721 is an actual file of an audio-formatted script. This file may be an .mp3, an .aiff file, a .wav file, an .mpg file, an .mov file, an .wmv file, or any other additional audio file type.

Link 722 labeled, Forward to a Friend, offers an option for a user to forward the listed audio-formatted scripts 711 to another person via an HTML formatted email.

Link 723 labeled ‘Subscribe Here’, is a link to subscribe to the website's media service 705. In one embodiment, this link leads a user to an iTunes Podcast directory which uses the iTunes software, where audio files can be accessed.

Link 724 labeled ‘Convert Your Screenplay’ is a section that explains the process of converting a text-formatted script into an audio-formatted script. In one embodiment, this information includes the recording process using live actors. Additionally, this section may include service provider 300's privacy policy and terms and conditions.

Link 725 labeled ‘For the Industry’ provides access to information that can be used to market the product and services offered by service provider 300. In one embodiment, this information may explain the efficiency of the system and how it can be marketed within the Film and TV industry.

Section 726 labeled ‘Submit Audio Screenplay Request’ will be the section where someone becomes a client. In one embodiment, the user may fill out a form with their information and their script or scripts information and submit the request to convert their text-formatted script to an audio-formatted script. Service provider 300 then receives that information and replies to the potential client with a quote.

Section 727 ‘Submit Copyright Request’ is a section of the website directed at providing potential clients an opportunity to copyright their script. In one embodiment, the client may fill out a form with their personal information along with their script or scripts information and submit the form to service provider 300. Service provider will receive that information and reply to the potential client with a quote.

Finally ‘Listed Audio Screenplays’ section 728 will have all the audio-formatted scripts listed from most recent to least recent that the client has submitted. Clicking on the link to this section provides a user access to links and sections 712-722.

A system and method for recording and distributing audio renditions of scripts has been described. The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims.

What is claimed is:

1. A method of creating an audio-formatted script, comprising:
receiving a text-formatted script from a first party;
instructing one or more live actors to orally perform said text-formatted script;
recording said oral performance of said text-formatted script to generate said audio-formatted script; and
providing said audio-formatted script to said first party.

2. The method of claim 1, further comprising:
receiving a request from a second party for a copy of said audio-formatted script, and
providing said audio-formatted script to said second party.

3. The method in claim 2, wherein recording said oral performance of said text-formatted script further comprises:
recording the descriptive, narrative, and dialogue components of said text-formatted script.

4. The method of claim 3, further comprising providing a copyright service to said first party or said second party.

5. The method of claim 4, further comprising engaging an agency to provide said one or more live actors.

6. The method of claim 5, further comprising providing credential information of said one or more live actors to an interested party.

7. The method of claim 6, further comprising providing credential information of an author of said text-formatted script to an interested party.

8. The method of claim 7, further comprising providing a brief description of said text-formatted script to an interested party.

9. The method of claim 8, further comprising receiving a comment regarding said audio-formatted script from an interested party and providing said comment to said interested party.

10. The method of claim 9, further comprising providing a security interface restricting access to said audio-formatted script.

11. The method in claim 10, further comprising recording the number of parties receiving said audio-formatted script and providing said number of parties receiving said audio-formatted script to an interested party.

12. The method of claim 11, wherein recording said oral performance of said text-formatted script to generate said audio-formatted script further comprises:
recording said audio-formatted script on a CD.

13. The method of claim 12, wherein recording said oral performance of said text-formatted script to generate said audio-formatted script further comprises:
recording said audio-formatted script on a minidisk or tape.

14. The method of claim 13, wherein recording said oral performance of said text-formatted script to generate said audio-formatted script further comprises:
recording said audio-formatted script on a media file.

15. The method of claim 14, wherein providing said audio-formatted script to said first party further comprises:
providing said audio-formatted script in a streaming media format.

16. The method of claim 15, wherein providing said audio-formatted script to said first party further comprises:
providing a website where downloadable mp3 files are made available to said first party.

17. The method of claim 16, wherein providing said audio-formatted script to said first party further comprises:
mailing said audio-formatted script to said first party.

18. The method in claim 17, wherein receiving a script from said first party further comprises accepting submission via email.

19. The method in claim 18, wherein receiving a script from said first party further comprises accepting submissions via regular mail.

20. The method in claim 19, wherein receiving a script from said first party further comprises accepting submissions via a website.

21. A system for converting text-formatted scripts into audio-formatted scripts and providing said audio-formatted scripts to an interested party comprising:
a server;
a processor, connected to said server, for:
receiving a request to convert a text-formatted script into an audio formatted script, and
providing one or more said audio-formatted scripts,
a memory, connected to said processor;
a database, residing in said memory, comprising a data repository associated with one or more users stored in said database, wherein said one or more data repository comprises one or more text-formatted scripts and one or more audio-formatted scripts created by said one or more live actors;
a network, connected to said database;
at least one user interface, connected to said network, for:
enabling said one or more users to upload said text-formatted script to said server,
enabling said one or more users to request said audio-formatted script generated form said text-formatted script,
providing said text-formatted script to a second user,
providing said audio-formatted script to said second user,
enabling said one or more users to download said audio-formatted script from said database,
enabling said one or more users to search said database for said audio-formatted script,
enabling said one or more users to listen to said audio-formatted script,
enabling said one or more users to download said audio-formatted script, and
enabling said one or more users to submit requests to said server for new said conversion of new text-formatted script into new audio-formatted script using said one or more live actors.

22. The system of claim 21, further comprising a security interface restricting access to said audio-formatted scripts.

23. The system of claim 22, wherein said user interface is also used for enabling said one or more users to submit comments regarding said audio-formatted scripts, and enabling said one or more users to receive comments regarding said audio-formatted scripts.

24. The system of claim 23, wherein said user interface is also used for enabling said user to download text files of said scripts uploaded by said server.

25. The system of claim 24, wherein said user interface is also used for enabling said user to receive credential information on said audio-formatted scripts.

26. The system of claim 25, wherein said user interface is also used for enabling said user to receive credential information on said text-formatted scripts.

27. The system of claim 26, wherein said user interface is also used for enabling said user to receive credential information on said live actors.

28. The system of claim 27, wherein said user interface is also used for enabling said user to receive brief description of the contents of each audio-formatted scripts, and enabling said user to receive brief description of the contents of each text-formatted file.

29. The system of claim 28, wherein said user interface is also used for enabling said user to receive information regarding the number of parties receiving said audio-formatted scripts.

30. The system of claim 29, wherein said user interface is also used for enabling said user to request server for a copyright service.

31. The system of claim 30, wherein said user interface is also used for enabling said user to submit requests for at least one CD, at least one minidisk, or at least one audio tape, of said audio-formatted scripts.

32. A method for creating an audio-formatted script, comprising:
receiving a text-formatted script from a first party;
instructing one or more live actors to orally perform said text-formatted script;
recording said oral performance of said text-formatted script to generate said audio-formatted script, wherein only the narrative and dialogue components of said text-formatted script are recorded;
providing said audio-formatted script to said first party;
receiving a request from a second party for a copy of said audio-formatted script;
providing said audio-formatted script to said second party;
providing a copyright service to said first party or said second party;
engaging an agency to provide said one or more actors;
providing credential information of a performing live actor to an interested party;
providing credential information of an author of said script to an interested party;
providing a brief description of said script to any interested party;
receiving a comment regarding said script from said interested party and providing said comment to a second interested party;
providing a security interface restricting access to said audio format;
recording the number of parties receiving said audio-formatted script and providing said number of parties receiving said audio-formatted script to said any interested party;
recording said audio-formatted script on a CD;
recording said audio-formatted script on a minidisk;
recording said audio-formatted script on a tape;
providing said script in a streaming audio format;
receiving a script from said first party comprising accepting submission via email;
receiving a script from said first party comprising accepting submissions via mail;
receiving a script from said first party comprising accepting submissions via a website;
providing a website where downloadable mp3 files of said audio-formatted script are made available to said first party; and
mailing said audio-formatted script to said first party.

33. A system for converting text-formatted scripts into audio-formatted scripts and providing said audio-formatted scripts to an interested party comprising:
a server;
a processor, connected to said server, for:
receiving a request to convert a text-formatted script into an audio formatted script, and
providing one or more said audio-formatted scripts,
a memory, connected to said processor;
a database, residing in said memory, comprising a data repository associated with one or more users stored in said database, wherein said one or more data repository comprises one or more audio files of one or more audio-formatted scripts created by said one or more live actors;
a network, connected to said server;
at least one user interface, connected to said network, for:
enabling said first one or more users to upload said text-formatted script to said server,
enabling said one or more users to request said audio-formatted script generated form said text-formatted script,
providing said text-formatted script to a second user, providing said audio-formatted script to said second user,
enabling one or more users to download said audio-formatted script from said database,
enabling said one or more users to search said database for said audio formatted script,
enabling said one or more users to listen to said audio-formatted script,
enabling said one or more users to download said audio file of a script,
enabling said one or more users to submit requests to said server for new said conversion of new text-formatted script into new audio-formatted script using said one or more live actors,
enabling a security interface restricting access to said audio-formatted scripts,
enabling said user to submit comments regarding said audio-formatted scripts,
enabling said user to receive comments regarding said audio-formatted scripts,
enabling said user to download text files of said scripts uploaded by said server,
enabling said user to receive credential information on said audio-formatted scripts,
enabling said user to receive credential information on said text files,
enabling said user to receive credential information on said live actors,
enabling said user to receive brief description of the contents of each audible file,
enabling said user to receive brief description of the contents of each text file,
enabling said user to receive information regarding the number of parties receiving said audio-formatted scripts,
enabling said user to request server for a copyright service, and
enabling said user to submit requests for at least one CD, at least one minidisk, or at least one audio tape, of said audio-formatted scripts.
